(19) United States
(12) Patent Application Publication
(10) Pub. No.: US 2020/0374907 A1
(43) Pub. Date: Nov. 26, 2020

(54) METHOD AND APPARATUS FOR REPORTING QUANTITY OF DATA FOR DIRECT-LINK TRANSMISSION IN A WIRELESS NETWORK

(71) Applicant: CANON KABUSHIKI KAISHA, Tokyo (JP)

(72) Inventors: Pascal VIGER, JANZE (FR); Julien SEVIN, SAINT AUBIN DU CORMIER (FR); Stéphane BARON, LE RHEU (FR); Patrice NEZOU, LIFFRE (FR)

(21) Appl. No.: 16/961,897

(22) PCT Filed: Jan. 15, 2019
(86) PCT No.: PCT/EP2019/050862

§ 371 Date: Jul. 13, 2020

(30) Foreign Application Priority Data
Jan. 17, 2018 (GB) 1800772.4

(51) Int. Cl. H04W 72/12; H04W 76/14

(52) U.S. Cl. CPC H04W 72/1284; H04W 84/12; H04W 76/14; H04W 72/121

(57) ABSTRACT

A method of communication in a wireless network comprising an access point and stations, the method comprising by at least one emitting station having data to be directly transmitted to at least one destination station different from the access point:
generating a status report to be transmitted to the access point, said status report indicating an amount of data of at least an emission buffer of the emitting station, said data been directed to one of the said at least one destination station; and
transmitting said status report to the access point-;
wherein said status report contains an identification element allowing the access point to reserve a wireless resource for the direct transmission between the emitting station and the destination station.

Accordingly, scheduled traffic by a station is made with an accurate amount of data for the direct link.

### FIELD OF THE INVENTION

The present invention relates generally to communication networks and more specifically to wireless communication methods in wireless network comprising a plurality of stations, one of these stations playing the role of an access point, the other stations being connected to the access point, and corresponding devices.

The invention finds application in wireless communication networks, in particular to the access of an 802.11ax composite channel and of OFDMA Resource Units forming for instance an 802.11ax composite channel for Uplink communication to the access point. One application of the method regards wireless data communication over a wireless communication network using Carrier Sense Multiple Access with Collision Avoidance (CSMA/CA), the network being accessible by a plurality of station devices.

### BACKGROUND OF THE INVENTION

A wireless network is composed of communicating stations. Typically, one of these stations plays the role of an access point. This access point station gives access to a more global network. All other stations, the non access point stations, are connected to the access point station. Using their connection to the access point station, the non access point stations have access to the global network. They also can communicate with other non access point station through the access point station. Some protocols have recently being introduced to also allow direct communication between non access point stations. In the following, the word “station” refers to any kind of stations. We will use the wording “access point station”, or in short “access point”, to refer to the station playing the role of access point and the wording “non access point station” to refer to the other stations not playing this role.

The IEEE 802.11 MAC standard defines a way wireless local area networks (WLANs) must work at the physical and medium access control (MAC) level. Typically, the 802.11 MAC (Medium Access Control) operating mode implements the well-known Distributed Coordination Function (DCF) which relies on a contention-based mechanism based on the so-called “Carrier Sense Multiple Access with Collision Avoidance” (CSMA/CA) technique.

The 802.11 medium access protocol standard or operating mode is mainly directed to the management of communication stations waiting for the wireless medium to become idle so as to try to access to the wireless medium. The network operating mode defined by the IEEE 802.11ac standard provides very high throughput (VHT) by, among other means, moving from the 2.4 GHz band which is deemed to be highly susceptible to interference to the 5 GHz band, thereby allowing for wider frequency contiguous channels of 80 MHz to be used, two of which may optionally be combined to get a 160 MHz composite channel as operating band of the wireless network.

The 802.11ac standard also provides control frames such as the Request-To-Send (RTS) and Clear-To-Send (CTS) frames, involved in a well-known RTS/CTS handshake, to allow reservation of composite channels of varying and predefined bandwidths of 20, 40 or 80 MHz, the composite channels being made of one or more channels that are contiguous within the operating band. The 160 MHz composite channel is possible by the combination of two 80 MHz composite channels within the 160 MHz operating band. The control frames specify the channel width (bandwidth) for the targeted (or “requested”) composite channel.

A composite channel therefore consists of a primary channel on which a given station performs EDCA backoff procedure to access the medium, and of at least one secondary channel, of for example 20 MHz each. The EDCA backoff procedure consists to randomly generate a backoff value which is a timer defining a waiting duration before the next attempt to emit on the channel when a collision has been detected. The primary channel is used by the communication stations to sense whether or not the channel is idle, and the primary channel can be extended using the secondary channel or channels to form a composite channel.

Given a tree breakdown of the operating band into elementary 20 MHz channels, some secondary channels are named tertiary or quaternary channels.

In 802.11ac, all the transmissions, and thus the possible composite channels, include the primary channel. This is because the stations perform full Carrier Sense Multiple Access/Collision Avoidance (CSMA/CA) and Network Allocation Vector (NAV) tracking on the primary channel only. The Network Allocation Vector defines a duration during which a station mustn't access the channel. The other channels are assigned as secondary channels, on which the 802.11ac stations have only capability of CCA (clear channel assessment), i.e. detection of an availability state/status (idle or busy) of said secondary channel.

An issue with the use of composite channels as defined in the 802.11n or 802.11ac is that the 802.11n and 802.11ac-compliant stations (i.e. HT stations standing for High Throughput stations) and the other legacy stations (i.e. non-HT stations compliant only with for instance 802.11a/b/g) have to co-exist within the same wireless network and thus have to share the 20 MHz channels.

To cope with this issue, the 802.11n and 802.11ac standards provide the possibility to duplicate control frames (e.g. RTS/CTS or CTS-to-Self or ACK frames to acknowledge correct or erroneous reception of the sent data) on each 20 MHz channel in an 802.11a legacy format (called as “non-HT”) to establish a protection of the requested channels forming the whole composite channel, during the TXOP. The TXOP is a bounded time interval in which stations are permitted to transfer a series of frames. A TXOP is defined by a start time and a maximum duration.

This is for any legacy 802.11a station that uses any of the 20 MHz channel involved in the composite channel to be aware of on-going communications on the 20 MHz channel used. As a result, the legacy station is prevented from initiating a new transmission until the end (as set on the NAV parameter) of the current composite channel TXOP granted to an 802.11n/ac station.

As originally proposed by 802.11n, a duplication of conventional 802.11a or “non-HT” transmission is provided to allow the two identical 20 MHz non-HT control frames to be sent simultaneously on both the primary channel and the secondary channels forming the requested and used composite channel.

This approach has been widened for 802.11ac to allow duplication over the channels forming an 80 MHz or 160 MHz composite channel. In the remainder of the present document, the “duplicated non-HT frame” or “duplicated non-HT control frame” or “duplicated control frame” means that the station device duplicates the conventional or “non-HT” transmission of a given control frame over secondary 20 MHz channels of the (40/80/160 MHz) operating band.

More recently, Institute of Electrical and Electronics Engineers (IEEE) officially approved the 802.11ax task group, as the successor of 802.11ac. The primary goal of the 802.11ax task group consists in seeking for an improvement in data speed to wireless communicating devices used in dense deployment scenarios.

Recent developments in the 802.11ax standard sought to optimize usage of the composite channel by multiple stations in a wireless network having an access point (AP). Indeed, typical contents have important amount of data, for instance related to high-definition audio-visual real-time and interactive content. Furthermore, it is well-known that the performance of the CSMA/CA protocol used in the IEEE 802.11 standard deteriorates rapidly as the number of stations and the amount of traffic increase, i.e. in dense WLAN scenarios.

In this context, multi-user (MU) transmission has been considered to allow multiple simultaneous transmissions to/from different users in both downlink (DL) and uplink (UL) directions from/to the access point. In the uplink to the access point, multi-user transmissions can be used to mitigate the collision probability by allowing multiple stations to simultaneously transmit.

To actually perform such multi-user transmission, it has been proposed to split a granted 20 MHz channel into one or more sub-channels, also referred to as resource units (RUs), that are shared in the frequency domain by the multiple stations, based for instance on Orthogonal Frequency Division Multiple Access (OFDMA) technique. Each resource unit may be defined by a number of tones, the 20 MHz channel containing up to 242 usable tones. A tone corresponds to the basic subcarrier to be used for transmission.

OFDMA is a multi-user variation of OFDM which has emerged as a new key technology to improve efficiency in advanced infrastructure-based wireless networks. It combines OFDM on the physical layer with Frequency Division Multiple Access (FDMA) on the MAC layer, allowing different subcarriers to be assigned to different stations in order to increase concurrency. Adjacent sub-carriers often experience similar channel conditions and are thus grouped to sub-channels: an OFDMA sub-channel or resource unit is thus a set of sub-carriers.

The multi-user feature of OFDMA allows the access point to assign different resource units to different stations in order to increase competition. This may help to reduce contention and collisions inside 802.11 networks.

As currently envisaged, the granularity of such OFDMA sub-channels is variable and may be finer than the original 20 MHz channel band. Typically, a 2 MHz or 5 MHz sub-channel may be contemplated as a minimal width, therefore defining for instance 9 sub-channels or resource units within a single 20 MHz channel.

To support multi-user uplink, i.e. uplink transmission to the 802.11ax access point (AP) during the granted TXOP, the 802.11ax access point has to provide signalling information for the legacy stations (non-802.11ax stations) to set their NAV in order to prevent them from accessing channels during the TXOP, and for the 802.11ax stations to determine the allocation of the resource units.

It has been proposed for the access point to send a trigger frame (TF) to the 802.11ax stations to trigger uplink communications. A trigger frame is a control frame derived from a RTS frame with an additional payload to communicate additional signalling information like resource units allocation for example.

A resource unit can be reserved for a specific station, in which case the access point indicates, in the TF, the station to which the resource unit is reserved (the Association ID (AID) is provided to indicate which 802.11ax station is allowed to use the resource unit). Such resource unit is called a Scheduled resource unit. The indicated station does not need to perform contention on accessing a scheduled resource unit reserved to it.

Another kind of resource units can be accessed by any stations using contention access. Such resource unit is not allocated to a particular station. It means that the stations compete for accessing such resource units. Such resource units are called Random resource units, and are indicated in the Trigger Frame with special station (STA) identification (e.g., value of Association ID (AID) is 0).

Since the access point performs contention on behalf of the STAs in this uplink OFDMA scheme, it is greatly preferable that the access point should be aware of which 802.11ax stations hold uplink packets to transmit and what their related emission buffer sizes are.

The 802.11e standard brought the quality of service mechanism. According to this mechanism the previously unique emission buffer has been split into four different emission buffers corresponding to four different access categories. Each access category corresponds to two different priorities, each emission buffer consequently holds data having two different priorities. Each of the eight priority level is identified by a traffic identifier (TID). The 802.11e standard has also brought the mechanism of buffer status report (BSR). This mechanism provides a means for a station to report to the access point station the amount of data held in an emission buffer ready to be transmitted to the access point station. The buffer status report mechanism is consequently adapted to report the amount of data held in the emission buffers corresponding to a given TID.

Thanks to this report, the access point is in charge of determining the width and duration of the uplink resource units for PPDU transmissions (PPDU length). All concerned 802.11ax stations (those explicitly solicited by the access point through a scheduled resource unit allocation, or those determined through applying the OFDMA random access procedure) make the uplink transmission with the indicated duration inside the indicated resource units. If a 802.11ax station's packet length is shorter or longer than the indicated duration, this packet should be padded or fragmented to make all uplink OFDMA transmissions finish at the same time (note that the access point is free to offer different resource unit widths inside a same MU UL transmission opportunity).

As one can note, knowledge of buffer status has become the critical point for the access point, acting as the central control entity for MU UL allocation: if stations without expected amount of uplink packets are polled for uplink OFDMA transmission, allocated uplink resources are wasted leading to system throughput degradation.

However, there are situations where the current version of data reporting according to the 802.11 standard is not satisfactory, and conducting the access point to not allocate, to one or the other of these several stations, the wireless resources over which communications may take place. Exemplary situation, corresponding to an increasing trend nowadays, is the presence of peer-to-peer (P2P) transmissions in between non-AP stations, (e.g. WiFi-Miracast or Wireless Display scenario). Even if such flows are not numerous, the amount of data per flow is huge (typically low-compressed video, from 1080p60 up to 8K UHD resolutions). This peer to peer data is buffered in the same emission buffers as the uplink traffic to the access point, even if it is not intended to be transmitted to the access point, but the current data reporting methods cannot be used to satisfactorily deliver corresponding traffic information to the AP.

### SUMMARY OF INVENTION

The present invention has been devised to address one or more of the foregoing concerns.

According to a first aspect of the invention there is provided a method of communication in a wireless network comprising an access point and stations, the method comprising by at least one emitting station having data to be directly transmitted to at least one destination station different from the access point:
generating a status report to be transmitted to the access point, said status report indicating an amount of data of at least an emission buffer of the emitting station, said data been directed to one of the said at least one destination station; and
transmitting said status report to the access point;
   wherein said status report contains an identification element allowing the access point to reserve a wireless resource for the direct transmission between the emitting station and the destination station.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a typical wireless communication system in which embodiments of the invention may be implemented;

FIGS. 2a, 2b and 2c illustrate the IEEE 802.11e EDCA involving access categories;

FIGS. 3a, 3b and 3c illustrates an enhanced Buffer Status report according to 802.11ax;

FIG. 4 illustrates the frame structure of a traffic specification (TSPEC) as defined in IEEE 802.11e.

FIG. 5 illustrates the TS info field of a TSPEC as defined in IEE 802.11e.

FIG. 6 shows a schematic representation a communication device or station in accordance with embodiments of the present invention;

FIG. 7 shows a block diagram schematically illustrating the architecture of a wireless communication device in accordance with embodiments of the present invention;

FIG. 8 illustrate a new format of report, suited for direct link transmissions and directed to an access point, according to embodiments of the invention;

FIG. 9 illustrates the TS info field of a TSPEC including if necessary a destination node identifier according to embodiments of the invention.

FIG. 10 illustrates, using a flowchart, embodiments of the invention implemented at a non-AP station to generate data reports according to embodiments of the invention.

### DETAILED DESCRIPTION

The invention will now be described by means of specific non-limiting exemplary embodiments and by reference to the figures.

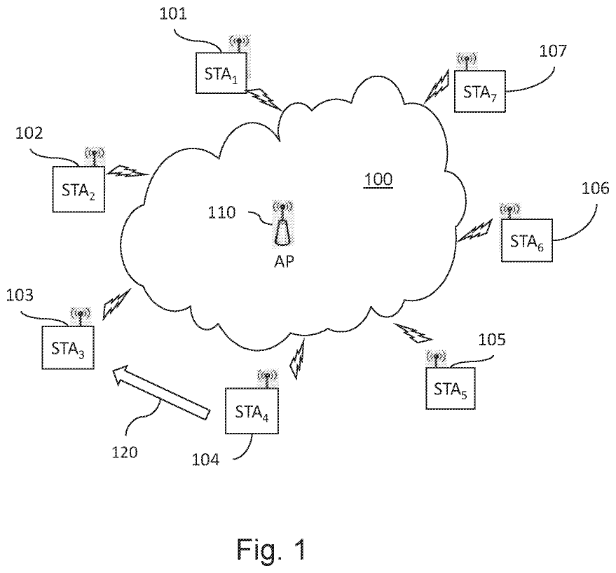

FIG. 1 illustrates a communication system in which several communication stations 101-107 exchange data frames over a radio transmission channel 100 of a wireless local area network (WLAN), under the management of a central station, or access point (AP) 110, also seen as a station of the network. The radio transmission channel 100 is defined by an operating frequency band constituted by a single channel or a plurality of channels forming a composite channel.

Access to the shared radio medium to send data frames is based on the CSMA/CA technique, for sensing the carrier and avoiding collision by separating concurrent transmissions in space and time. Carrier sensing in CSMA/CA is performed by both physical and virtual mechanisms. Virtual carrier sensing is achieved by transmitting control frames to reserve the medium prior to transmission of data frames. Next, a source or transmitting station first attempts, through the physical mechanism, to sense a medium that has been idle for at least one DIFS (standing for DCF InterFrame Spacing) time period, before transmitting data frames.

However, if it is sensed that the shared radio medium is busy during the DIFS period, the source station continues to wait until the radio medium becomes idle.

The wireless communication system of FIG. 1 comprises a physical access point station 110 configured to manage the WLAN BSS (Basic Service Set), i.e. a group of stations. Such BSS managed by an access point is called an infrastructure BSS. In the following, the term BSS will be used as an equivalent of infrastructure BSS. Once the BSS is established (AP wakes up), it is organized around the Access Point which can bridge traffic out the BSS onto a distribution network, or inside the BSS. Thus, members of the BSS talk to the access point only, which is in charge of relaying frames if targeted to another station of the BSS.

In order to avoid relaying communications by the access point, and thus optimizing wireless channel usage, some protocols have emerged to offer direct communications 120 between stations.

Given the wide adoption of 802.11 in many kinds of devices, a natural way for the technology to progress is to provide station to station (peer-to-peer, P2P) connectivity, i.e. without the need of an Access Point (AP).

Direct Link Setup (DLS), published in 802.11e, allows direct station-to-station frame transfer within a basic service set. This is designed primarily for consumer use, where station to station transfer is more commonly used. However, DLS requires participation from the access point to facilitate the more efficient direct communication, and few, if any, access points have the necessary support for this.

Later, 802.11z published the Tunneled Direct Link Setup (TDLS), allowing devices to perform more efficient direct station to station frame transfers without support from the access point. Wi-Fi Alliance added a certification program for TDLS in 2012, and describes this feature as technology that enables stations to link directly to one another when connected to a traditional infrastructure network.

Both DLS and TLDS require that stations be associated with the same access point.

In complement, nearby communication between devices not associated with the same access point can be performed using technologies like Wi-Fi Direct, initially called Wi-Fi P2P (peer to peer), which is also a technology defined by the Wi-Fi Alliance aiming at enhancing direct device to device communications in Wi-Fi. Given the wide base of devices provided with Wi-Fi capabilities and the fact that Wi-Fi Direct can be entirely software implemented over traditional 802.11 radios, this technology is expected to have a significant impact.

Common electronic devices having undergone certification of Wi-Fi, such as mobile terminals, printers, monitors, TVs, and game consoles, may perform direct wireless communication with each other using the Wi-Fi Direct or TDLS technologies.

Communications inside a P2P group are concurrent to communications of the infrastructure network (those including the access point 110). That is, the stations involved at the same time in the P2P communications and BSS network have their transmission queue(s) served with data from both traffic modes.

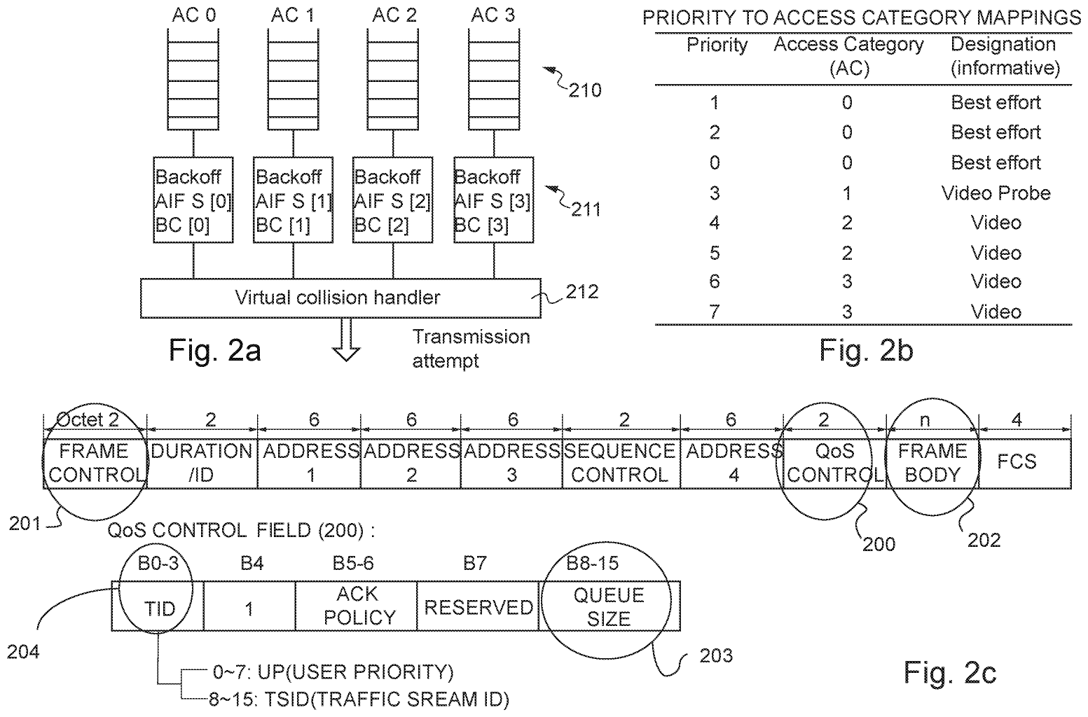

FIGS. 2a, 2b and 2c illustrate the IEEE 802.11e EDCA involving access categories, in order to improve the quality of service (QoS). In the original DCF standard, a communication station includes only one transmission queue/buffer. However, since a subsequent data frame cannot be transmitted until the transmission/retransmission of a preceding frame ends, the delay in transmitting/retransmitting the preceding frame prevents the communication from having QoS.

The IEEE 802.11e has overturned this deficiency in providing quality of service (QoS) enhancements to make more efficient use of the wireless medium. This standard relies on a coordination function, called Hybrid Coordination Function (HCF), which has two modes of operation: Enhanced Distributed Channel Access (EDCA) and HCF Controlled Channel Access (HCCA).

EDCA enhances or extends functionality of the original access DCF method: EDCA has been designed for support of prioritized traffic similar to DiffSery (Differentiated Services), which is a protocol for specifying and controlling network traffic by class so that certain types of traffic get precedence. EDCA is the dominant channel access mechanism in WLANs because it features a distributed and easily deployed mechanism. As will be apparent further in the description, the EDCA medium access is still existing in 802.11ax standard as the fundamental legacy protocol, that is to say it is in concurrency to the newly introduced Multi-User OFDMA of 802.11ax.

The above deficiency of failing to have satisfactory QoS due to delay in frame retransmission has been solved with a plurality of transmission queues/buffers. QoS support in EDCA is achieved with the introduction of four Access Categories (ACs), and thereby of four corresponding emission buffers (or transmission/traffic queues or buffers) 210. Of course, another number of traffic queues may be contemplated. Each AC has its own traffic queue/buffer to store corresponding data frames to be transmitted on the network. The data frames, namely the MSDUs, incoming from an upper layer of the protocol stack are mapped onto one of the four AC queues/buffers and thus input in the mapped AC buffer.

Each AC has also its own set of channel access parameters or “queue backoff parameters”, and is associated with a priority value, thus defining traffic of higher or lower priority of MSDUs. Thus, there is a plurality of traffic queues for serving data traffic at different priorities. That means that each AC, and corresponding buffer, acts as an independent DCF contending entity including its respective queue backoff engine 211. Thus, each queue backoff engine 211 is associated with a respective traffic queue for computing a respective queue backoff value to be used to contend access to at least one communication channel in order to transmit data stored in the respective traffic queue.

It results that the ACs within the same communication station compete one with each other to access the wireless medium and to obtain a transmission opportunity. Service differentiation between the ACs is achieved by setting different queue backoff parameters between the ACs, such as different contention window parameters (CWₘᵢₙ, CWₘₐₓ), different arbitration interframe spaces (AIFS), and different transmission opportunity duration limits (TXOP_Limit).

With EDCA, high priority traffic has a higher chance of being sent than low priority traffic: a station with high priority traffic waits a little less (low CW) before it sends its packet, on average, than a station with low priority traffic.

The four AC buffers 210 are shown in FIG. 2a. Buffers AC3 and AC2 are usually reserved for real-time applications (e.g., voice or video transmission). They have, respectively, the highest priority and the penultimate highest priority. Buffers AC1 and AC0 are reserved for best effort and background traffic. They have, respectively, the penultimate lowest priority and the lowest priority.

Each data unit, MSDU, arriving at the MAC layer from an upper layer (e.g. Link layer) with a type of traffic (TID) priority is mapped into an AC according to mapping rules. FIG. 2b shows an example of mapping between eight priorities of traffic class (TID values between 0-7 are considered user priorities and these are identical to the IEEE 802.1D priority tags) and the four ACs. The data frame is then stored in the buffer corresponding to the mapped AC.

When the EDCA backoff procedure for a traffic queue (or an AC) ends, the MAC controller (reference 704 in FIG. 7 below) of the transmitting station transmits a data frame from this traffic queue to the physical layer for transmission onto the wireless communication network.

Since the ACs operate concurrently in accessing the wireless medium, it may happen that two ACs of the same communication station have their backoff ending simultaneously. In such a situation, a virtual collision handler 212 of the MAC controller operates a selection of the AC having the highest priority, as shown in FIG. 2b, between the conflicting ACs, and gives up transmission of data frames from the ACs having lower priorities. Then, the virtual collision handler commands those ACs having lower priorities to start again a backoff operation using an increased CW value.

FIG. 2c illustrates configurations of a MAC data frame and a QoS control field 200 included in the header of the IEEE 802.11e MAC frame. The MAC data frame also includes, among other fields, a Frame Control header 201 and a frame body 202. As represented in the Figure, the QoS control field 200 is made of two bytes, including the following information items:
Bits B0 to B3 are used to store a traffic identifier (TID) 204 which identifies a traffic stream. The traffic identifier takes the value of the transmission priority value (User Priority UP, value between 0 and 7—see FIG. 2b) corresponding to the data conveyed by the data frame or takes the value of a traffic stream identifier, TSID, value between 8 and 15, for other data streams;
Bit B4 is used by a non-AP station to differentiate the meaning of bits B8-B15 and is detailed here below;
Bits B5 and B6 define the ACK policy subfield which specifies the acknowledgment policy associated with the data frame. This subfield is used to determine how the data frame has to be acknowledged by the receiving station; normal ACK, no ACK or Block ACK.
Bit B7 is reserved, meaning not used by the current 802.11 standards; and
If bit B4 is set to 1, bits B8-B15 represent the “queue size” subfield 203, to indicate the amount of buffered traffic for a given TID at the non-AP station sending this frame. The queue size value is the total size, rounded up to the nearest multiple of 256 octets and expressed in units of 256 octets, of all packets buffered for the specified TID. The access point may use this information to determine the next TXOP duration it will grant to the station. A queue size of 0 indicates the absence of any buffered traffic for that TID. A queue size of 255 indicates an unspecified or unknown size for that TID 204.
Alternatively to the “queue size” usage, if bit B4 is set to 0, bits B8-B15 represent the “TXOP Duration Requested” subfield. It indicates the duration, in units of 32 μs, that the sending station determines it needs for its next TXOP for the specified TID. Of course, the “TXOP Duration Requested” provides an equivalent request as the “queue size”, as they both consider all packets buffered for the specified TID.

The 802.11e MAC frame format, and more particularly the QoS Control field 200, have been kept for the up and corner standard versions as now described. The following description will be done with “queue size” format for the buffer status reports, as it is the largest usage. The invention remains applicable to the “TXOP Duration Requested” format.

To meet the ever-increasing demand for faster wireless networks to support bandwidth-intensive applications, 802.11ac is targeting larger bandwidth transmission through multi-channel operations. 802.11ac channel allocation now supports composite channel bandwidth of 20 MHz, 40 MHz, 80 MHz or 160 MHz.

IEEE 802.11ac introduces support of a restricted number of predefined subsets of 20 MHz channels to form the sole predefined composite channel configurations that are available for reservation by any 802.11ac station on the wireless network to transmit data.

A station is granted a TxOP through the enhanced distributed channel access (EDCA) mechanism on a “primary channel”. Indeed, for each composite channel having a bandwidth, 802.11ac designates one channel as “primary” meaning that it is used for contending for access to the composite channel. The primary 20 MHz channel is common to all stations (STAs) belonging to the same basic set, i.e. managed by or registered to the same local Access Point (AP).

However, to make sure that no other legacy station (i.e. not belonging to the same set) uses the secondary channels, it is provided that the control frames (e.g. RTS frame/CTS frame) reserving the composite channel are duplicated over each 20 MHz channel of such composite channel.

As addressed earlier, the IEEE 802.11ac standard enables up to four, or even eight, 20 MHz channels to be bound. Because of the limited number of channels (19 in the 5 GHz band in Europe), channel saturation becomes problematic. Indeed, in densely populated areas, the 5 GHz band will surely tend to saturate even with a 20 or 40 MHz bandwidth usage per Wireless-LAN cell. Developments in the 802.11ax standard seek to enhance efficiency and usage of the wireless channel for dense environments.

In this perspective, one may consider multi-user (MU) transmission features, allowing multiple simultaneous transmissions to different users in both downlink and uplink directions. In the uplink (UL), multi-user transmissions can be used to mitigate the collision probability by allowing multiple stations to simultaneously transmit.

To actually perform such multi-user transmission, it has been proposed to split at least one granted 20 MHz channel into elementary sub-channels, also referred to as sub-carriers or resource units (RUs), that are shared in the frequency domain by multiple users, based for instance on Orthogonal Frequency Division Multiple Access (OFDMA) technique.

Contrary to downlink OFDMA wherein the access point can directly send multiple data to multiple stations, supported by specific indications inside the PLCP header, a trigger mechanism has been adopted for the access point to trigger uplink communications from various stations.

To support an uplink multi-user transmission, during a pre-empted TXOP, the 802.11ax access point has to provide signalling information for both legacy stations, namely non-802.11ax stations, to set their NAV to prevent any transmission during the TXOP, and for 802.11ax stations to determine the Resource Units allocation.

In the following description, the term legacy stations refers to non-802.11ax stations, meaning 802.11 stations of previous technologies that do not support OFDMA communications.

The AP provides transmission schedules to clients using a new control frame called a “trigger frame” (TF), which specifies which 802.11ax stations can transmit during the specified time and which subsets of OFDMA sub-carriers they will use. The bandwidth or width of the targeted composite channel is signalled in the TF frame, meaning that the 20, 40, 80 or 160 MHz value is added. The TF frame is sent over the primary 20 MHz channel and duplicated, replicated, on each other 20 MHz channels forming the targeted composite channel. Thanks to the duplication of the trigger frame, it is expected that every nearby legacy station receiving the TF on its primary channel, then sets its NAV to the value specified in the TF frame. This prevents these legacy stations from accessing the channels of the targeted composite channel during the TXOP.

Based on an access point's decision, the trigger frame may define a plurality of OFDMA sub-carriers called resource units (RUs). The multi-user feature of OFDMA allows the access point to assign different resource units to different stations in order to increase competition. This may help to reduce contention and collisions inside 802.11 networks.

The trigger frame may designate “Scheduled resource units”, which may be reserved by the access point for certain stations in which case no contention for accessing such resource units is needed for these stations. Such resource units and their corresponding scheduled stations are indicated in the trigger frame. For instance, a station identifier, such as the Association ID (AID) assigned to each station upon registration, is added in association with each Scheduled resource unit in order to explicitly indicate the station that is allowed to use each Scheduled resource unit. Such transmission mode is concurrent to the classical EDCA, and the uplink data to be sent to the access point is picked from the EDCA queues 210.

The trigger frame may also designate “Random resource units”, in addition or in replacement of the “Scheduled resource units”, which can be randomly accessed by the stations of the network. In other words, Random resource units designated or allocated by the access point in the TF may serve as basis for contention between stations willing to access the communication medium for sending data. A collision occurs when two or more stations attempt to transmit at the same time over the same resource unit. An AID equal to 0 may be used to identify random resource units.

Since the receiver, the access point, performs contention on behalf of the non-AP stations in the uplink OFDMA, the access point should be aware of both which non-AP stations have uplink packets and what their buffer 210 sizes are. If non-AP stations without uplink packets are polled for uplink OFDMA transmission, then allocated uplink resources are wasted thus leading to wireless medium usage degradation.

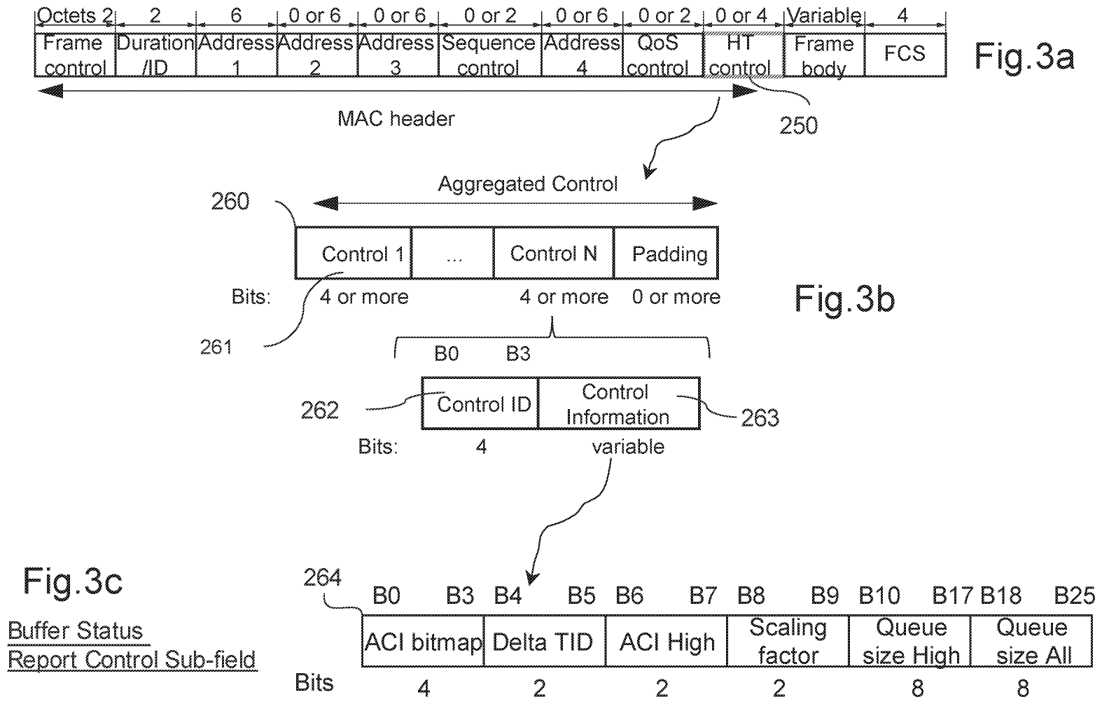

The standard proposes that buffer status report from 802.11ax stations may be utilized to support the efficient uplink MU operation by the access point. A current version of IEEE 802.11ax extends the usage of Queue size information 203 in a new QoS Control field, namely HE Control (260), and possibly in replacement of QoS Control field for 802.11ax frames, in order to inform about the several queues 210, instead on only one, according to 802.11e. This is now described now with reference to FIGS. 3a to 3c.

In replacement to HT-Control field 250 introduced by the 802.11n version, the A-Control subfield 260 aggregates several control fields, which is a sequence of one or more Control subfields 261. The length of the A-Control subfield 260 is equal to 30 bits. Each Control subfield 261 is composed of a Control ID 262 subfield indicating the type of information carried in the Control Information subfield 263 that follows. Padding bits are added to reach a 30-bit A-Control subfield if necessary.

Various type of information may thus be provided through the A-Control subfield 260. For instance, operating mode may be indicated in Control Information subfield 263 when Control ID 262 is 1. Also, power data may be indicated in Control Information subfield 263 when Control ID 262 is 4.

If the Control ID subfield is 3, the Control Information subfield of the Control subfield contains buffer status information (264). STA may report the buffer status for a preferred AC, or for all AC queues.

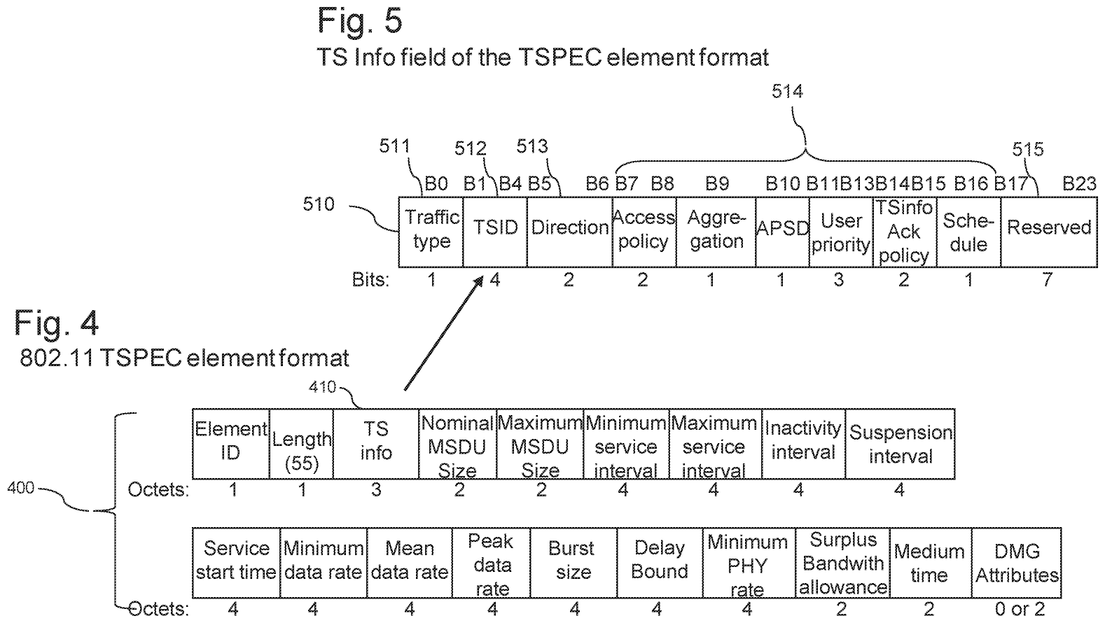

As 802.11ax system is enabling scheduling/MU operation, the need for AP to obtain accurate and timely information regarding stations' persistent traffic characteristics and QoS requirements is critical for APs to satisfy stations' QoS requirements. FIG. 4 illustrates the frame structure of a traffic specification (TSPEC) as defined in IEEE 802.11e, that is a good candidate that can be used for such purpose.

The TSPEC element (400) contains a set of parameters/fields that define the characteristics and QoS expectations of a traffic flow for a given station. It allows a set of parameters more extensive than might be needed, or might be available, for any particular instance of parameterized QoS traffic. Unless indicated otherwise, fields that follow the TS Info field are set to 0 for any unspecified parameter values. STAs set the value of any parameters to unspecified if they have no information for setting that parameter.

In particular the TSPEC element contains a field referred to as “TS info” field (410) which contains the information to identify a traffic stream. Field 410 is described with reference to FIG. 5.

FIG. 5 illustrates the TS info field of a TSPEC as defined in IEEE 802.11e. It contains a set of parameters/fields allowing to identify the stream. TS info field 510 contains a subfield 511 referred to as traffic type, a subfield 512 referred to as TSID and a subfield 513 referred to as Direction. Subfield 511 is a single bit and is set to 1 for a periodic traffic pattern (e.g., isochronous TS of MSDUs or A-MSDUs, with constant or variable sizes, that are originated at fixed rate) or set to 0 for an aperiodic, or unspecified, traffic pattern (e.g., asynchronous TS of low-duty cycles). Subfield 512 is 4 bits in length and contains a value that is a TSID. Subfield 513 specifies the direction of data carried by the traffic stream. It is 2 bits in length (identified by bit 5 and bit 6) with the following value:

If bit 5 is equal to 0 and bit 6 is equal to 0, it means that the direction of the traffic stream is uplink (from a non-AP station to AP). If bit 5 is equal to 1 and bit 6 is equal to 0, it means that the direction of the traffic stream is downlink (from AP to a non-AP station). If bit 5 is equal to 0 and bit 6 is equal to 1, it means that the direction of the traffic stream is direct link (from a non-AP station to another non-AP station). If bit 5 is equal to 1 and bit 6 is equal to 1, it means that the direction of the traffic stream is bidirectional link (both downlink and uplink with the same parameters). Moreover, TS info field 510 contains a set of additional fields 514 including an Access Policy subfield (2 bits), an Aggregation subfield (1 bit), an APSD subfield (1 bit), a User Priority subfield (3 bits), a TS Info Ack Policy subfield (2 bits), a schedule subfield (1 bit). Moreover it contains a Reserved subfield 514 (7 bits).

The station includes the TSPEC in some action frames, like the Add Traffic Stream (ADDTS), to perform an admission request or closure of the characterized traffic.

Once the access point has obtained traffic specifications and/or buffer reports for a set of stations of its BSS, it can specifically poll them through scheduled resource unit allocation. This allocation is transmitted using a trigger frame for data transmission. Then, the stations with allocated resource units emits their buffered data inside their allocated resource unit. As the MU UL/DL OFDMA transmissions on all the resource units of the composite channel should be aligned in time, the station may provide padding payload in case of no more data can be sent inside the assigned resource unit. This may happen, for example, if no more data is buffered for transmission, or if the emitting station doesn't want to fragment any remaining data frame.

The access point is able to manage the resource unit size according to the reported needs. The access point may schedule the uplink resource unit(s) during the TXOP period to any of the stations having sent a report.

As recalled, communications inside a P2P group are concurrent to communications of the infrastructure network, including the access point 110. That is, the stations involved at the same time in the P2P communications and BSS network have their transmission queue(s) served with data from both traffic modes.

The 802.11 classical usage for constructing/using such reports is no longer adapted to this transmission concurrency, as only the needs towards AP is reported inside the queue size information of their buffer reports or flow characteristic information delivered by the TSPEC. Anyway, as will become apparent later in the disclosure, the current format of the various reports of the art is not adapted for conveying information about P2P communications.

This conducts to misinform the access point about real expected resources, which then is misled for allocation resource units to 802.1 lax stations. This situation has not been addressed by the 802.11ax standardization group, because it concentrates its activities around the access point traffic. The P2P traffics is considered as “background” communications of less importance.

This issue is really detrimental for dense scenarios addressed by 802.11ax, for at least the following 2 reasons.

Important wireless resource allocation may be used twice, because relayed by the AP. In addition to a worse efficiency of the global system, energy for transmitting twice is consumed by the 802.11ax station.

The 802.11ax stations with P2P communications will still require an EDCA access for emitting its pending traffic, that shall grant by itself. This increase the contention onto the wireless medium.

The present invention seeks to improve the reservation of the wireless resources for multi-user transmission, particularly for direct-link. To do so, an aim of this invention is to provide more reliable data reports from an 802.11ax station to the 802.11ax access point, as a countermeasure to the raised issues.

An exemplary wireless network for the implementation of embodiments of the invention is an IEEE 802.11ax network or one of its future versions. However, the invention applies to any wireless network comprising stations, for instance an access point 110 and a plurality of stations 101-107 exchanging data through a single-user, for example P2P communication between stations, and multi-user transmissions from non-AP stations to the access point. The invention is especially suitable for data transmission in resource units of an IEEE 802.11ax network and its future versions.

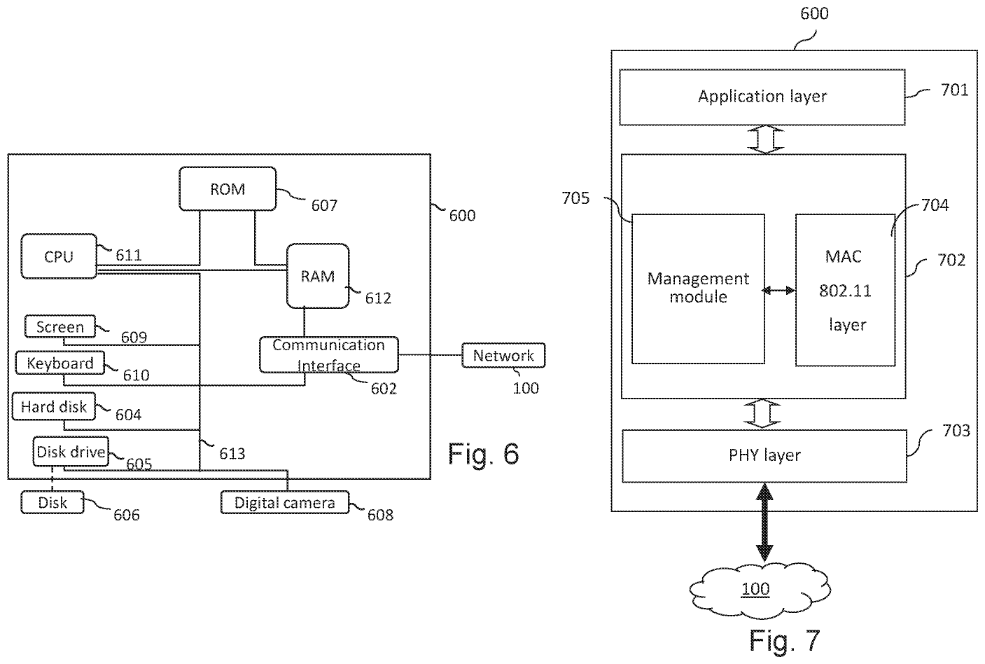

FIG. 6 schematically illustrates a communication device 600 of the radio network 100, configured to implement at least one embodiment of the present invention. The communication device 600 may preferably be a device such as a micro-computer, a workstation or a light portable device. The communication device 600 comprises a communication bus 613 to which there are preferably connected:
a central processing unit 611, such as a microprocessor, denoted CPU;
a read only memory 607, denoted ROM, for storing computer programs for implementing the invention;
a random access memory 612, denoted RAM, for storing the executable code of methods according to embodiments of the invention as well as the registers adapted to record variables and parameters necessary for implementing methods according to embodiments of the invention; and
at least one communication interface 602 connected to the radio communication network 100 over which digital data packets or frames or control frames are transmitted, for example a wireless communication network according to the 802.11ax protocol. The frames are written from a FIFO sending memory in RAM 612 to the network interface for transmission or are read from the network interface for reception and writing into a FIFO receiving memory in RAM 612 under the control of a software application running in the CPU 611.

Optionally, the communication device 600 may also include the following components:
a data storage means 604 such as a hard disk, for storing computer programs for implementing methods according to one or more embodiments of the invention;
a disk drive 605 for a disk 606, the disk drive being adapted to read data from the disk 606 or to write data onto said disk;
a screen 609 for displaying decoded data and/or serving as a graphical interface with the user, by means of a keyboard 610 or any other pointing means.

The communication device 600 may be optionally connected to various peripherals, such as for example a digital camera 608, each being connected to an input/output card (not shown) so as to supply data to the communication device 600.

Preferably the communication bus provides communication and interoperability between the various elements included in the communication device 600 or connected to it. The representation of the bus is not limiting and in particular the central processing unit is operable to communicate instructions to any element of the communication device 600 directly or by means of another element of the communication device 600.

The disk 606 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the apparatus, possibly removable and adapted to store one or more programs whose execution enables a method according to the invention to be implemented.

The executable code may optionally be stored either in read only memory 607, on the hard disk 604 or on a removable digital medium such as for example a disk 606 as described previously. According to an optional variant, the executable code of the programs can be received by means of the communication network 603, via the interface 602, in order to be stored in one of the storage means of the communication device 600, such as the hard disk 604, before being executed.

The central processing unit 611 is preferably adapted to control and direct the execution of the instructions or portions of software code of the program or programs according to the invention, which instructions are stored in one of the aforementioned storage means. On powering up, the program or programs that are stored in a non-volatile memory, for example on the hard disk 604 or in the read only memory 607, are transferred into the random access memory 612, which then contains the executable code of the program or programs, as well as registers for storing the variables and parameters necessary for implementing the invention.

In a preferred embodiment, the apparatus is a programmable apparatus which uses software to implement the invention. However, alternatively, the present invention may be implemented in hardware (for example, in the form of an Application Specific Integrated Circuit or ASIC).

FIG. 7 is a block diagram schematically illustrating the logical architecture of the communication device or station 600, either one of the stations 101-107 adapted to carry out, at least partially, the invention. As illustrated, station 600 comprises a physical (PHY) layer block 703, a MAC layer block 702, and an application layer block 701.

The PHY layer block 703 (e.g. a 802.11 standardized PHY layer) has the task of formatting, modulating on or demodulating from any 20 MHz channel or the composite channel, and thus sending or receiving frames over the radio medium used 100, such as 802.11 frames, for instance single-user frames, such as control frames (RTS/CTS/ACK/Trigger Frame), MAC data and management frames, based on a 20 MHz width to interact with legacy 802.11 stations, as well as MAC data frames of OFDMA type having smaller width than 20 MHz legacy (typically 2 or 5 MHz) to/from that radio medium.

The MAC layer block or controller 702 preferably comprises a MAC 802.11 layer 704 implementing conventional 802.11ax MAC operations, and one additional block 705 for carrying out, at least partially, embodiments of the invention. The MAC layer block 702 may optionally be implemented in software, which software is loaded into RAM 612 and executed by CPU 611.

Preferably, the additional block 705 is a report management module which drives the station in computing data information linked with direct link transmission needs to be provided for a requesting station, in particularly wherein the requesting station is the access point station that will use this reported information for allocating wireless resources (e.g. uplink OFDMA or SU access) to the station 600.

On top of the Figure, application layer block 701 runs an application that generates and receives data packets, for example data packets of a video stream. Application layer block 701 represents all the stack layers above MAC layer according to ISO standardization.

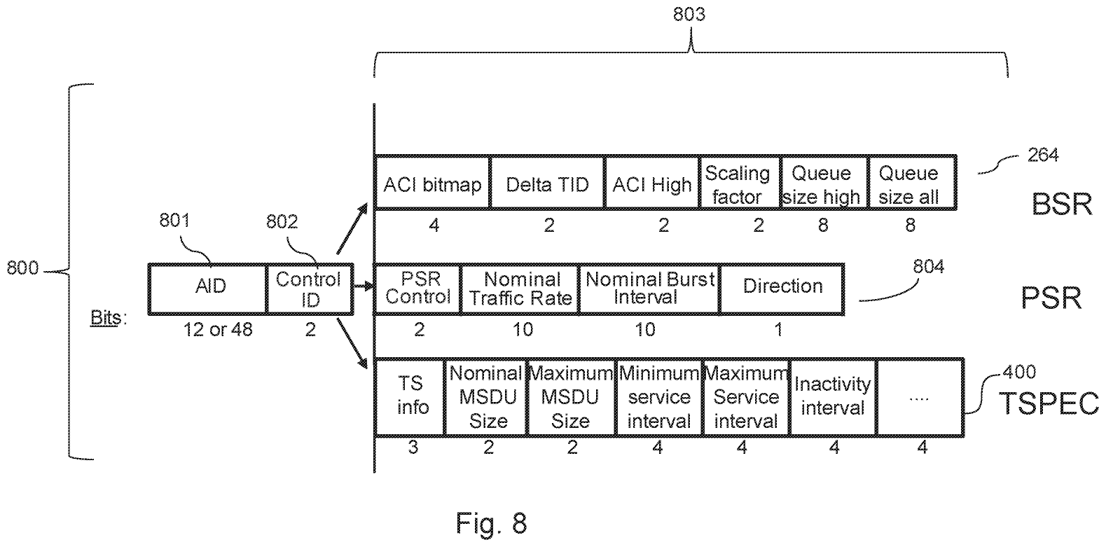

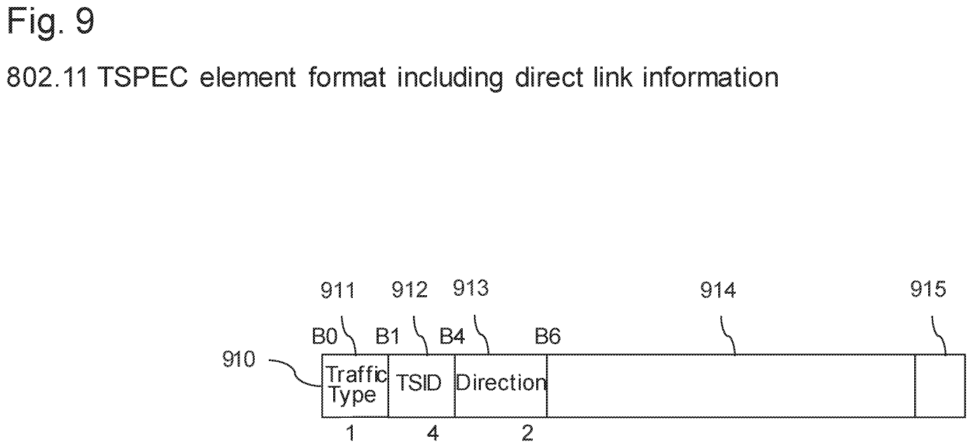

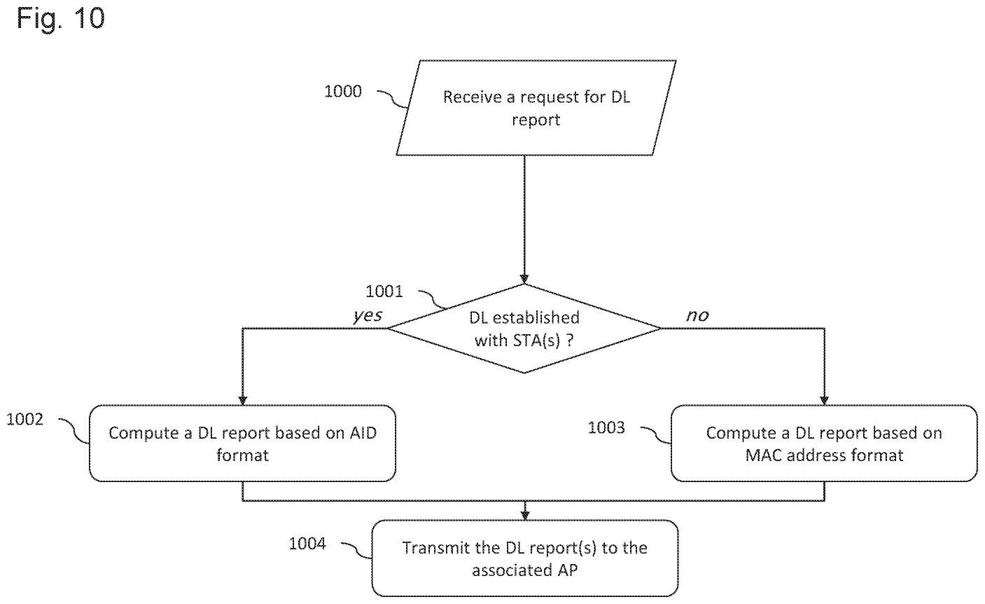

Embodiments of the present invention are now illustrated through different flowcharts describing the behaviour at the stations' side (FIG. 10) and through different report formats (FIGS. 8 and 9). These embodiments supplement the 802.11ax by specifying how the stations can report their status to the access point, either in the existing 802.11e frames or in newly 802.11ax multi-user QoS Data/Null frames

More specifically, to report the status to the access point, an 802.11ax station, when considering the amount of data (to be) queued in direction to another non-AP station (i.e. for direct-link transmission), should indicate the destination station inside its status report.

For example, this report includes transmissions from 802.11ax stations to a peer non-AP 802.11ax station once a direct link transmission is established in between these at least two stations, and the peer non-AP 802.11ax station is identified. This is especially possible for DLS sessions, because this protocol envisages exchanging the stations' AID. We recall that a station obtains an Association Identifier (AID) value when the station associates to the BSS (or in other words, gets associated with the AP).

In a second embodiment, the direct link session is identified instead of the peer non-AP 802.11ax station. This is especially possible for DLS sessions, because the AP is involved in the direct link establishment (DLS is allowed by AP).

Alternatively, for non-established direct link sessions, the AID of a peer non-AP 802.11ax destination station maybe unknown by the non-AP 802.11ax station generating the report towards the AP. Thus, the invention introduces the usage of a MAC address instead of a station identifier (AID), which is an address universally known and more especially shared with the AP (because the AP has allowed registration onto the BSS to the peer non-AP 802.11ax destination station). The AP would then retrieve the AID from the received MAC address, and use the AID for subsequent resource allocation.

Embodiments of the present invention are now illustrated through a new format of report for direct link traffics (FIG. 8).

This format 800 aims to be generic, in the sense it could handle various types of reports (e.g. buffer status, TSPEC, some reduced TSPEC format like PSR as shown in the figure, or any combination of those).

The report 800 can be conveyed through the A-Control subfield 260. For instance, it may be indicated in Control Information subfield 263 when Control ID takes the value 7 (values 8 up to 15 remain reserved).

The first field 801 identifies the direct link session. Depending to the information present at the non-AP station generating the report, it may appear that the station does not know the AID of its peer destination station. In that case, the MAC address of peer destination station is specified: the field becomes 48-bit long (compared to 12-bit long for AID).

In an embodiment not shown in the figure, a bit precedes the field 801 in order to specify the duration of 801 (12 or 48 bits).

In a second embodiment, the AID can also convey a session identifier corresponding to the direct link session (e.g. identifier of the established direct link). This can be envisaged when the AP has allowed the P2P session (like for DLS protocol) and has granted an identifier for this session. In a preferred approach, the session identifier lies in an AID format of 12 bits. It is up to the AP to allocate distinct values compared to AID of stations.

Then, a Control ID field 802 offers support for the various formats of reports 803.
Typically, a Control ID value of 0 indicates that the reported information follows the BSR format 264; the whole report 800 then indicates at least a buffer size information representative of an amount of data buffered per TID for a given final destination station.
a Control ID value of 1 indicates that the reported information follows the TSPEC format according to 802.11e; the whole report 800 then indicates a traffic characteristic information representative of a direct link session directed to a given final destination station.
a Control ID value of 2 indicates that the reported information follows the PSR format 804 (standing for Persistent Scheduling Request (PSR) information), that is used to convey essential traffic characteristics for a P2P traffic (that is to say a reduced format compared to the original TSPEC).

The format of report 800 is provided for the sake of illustration: any other combination of report information can be envisaged considering that an identifier corresponding to the P2P traffic shall be included (anyway the identifier refers to a station or an active direct link session). As example, with regards to FIG. 9, the AID can be specified inside the TSPEC.

The generic format offers various possibilities of report (adding some new information with regards to the direct link), without increasing the values of control ID 262 of Aggregated Control format 200.

The non-AP station is thus offered various possibilities of reports. Of course, they are not exclusive: as example, a BSR report can follow a TSPEC report for the same established traffic, in a subsequent control 261 of the same MAC frame.

It is up to the station to decide which type of report is required. It seems preferable to first emit report of TSPEC/PSR type before a direct link session has started, and then emit regularly BSR type report along the session activity.

FIG. 9 illustrates the TS info field of a TSPEC including if necessary a destination node identifier according to embodiments of the invention. It contains also a set of parameters/fields allowing to identify the stream. But the direct link streams are identified differently compared to TS info field described with reference to FIG. 5. The TS info field 910 contains also traffic type subfield (911), TSID subfield (912) and direction subfield (913) corresponding respectively to subfields 511, 512 and 513 described with reference to FIG. 5. According to the value of the subfield 513, the next fields 914 and 915 may be different from 514 and 515. If the value of the subfield 513 is equal to 0 for bit 5 and 0 for bit 6, or 1 for bit 5 and 0 for bit 6, or 1 for bit 5 and 0 for bit 6, subfield 914 and subfield 915 corresponds to subfields 514 and 515. If the value of the subfield 513 is equal to 0 for bit 5 and 1 for bit 6, field 914 corresponds to association identifier (12 bits) of the destination address of the direct link session corresponding to the TSPEC (It means that the direct link session is already established). In such a case, field 915 is yet a Reserved subfield but its size is 6 bits (and not 7 bits as subfield 515).

The 802.11ax station includes this new format of TSPEC in some action frames, like the Add Traffic Stream (ADDTS), to perform an indication request or closure of the characterized direct link traffic.

FIG. 10 illustrates, using a flowchart, embodiments of the invention implemented at a non-AP station to generate data reports according to embodiments of the invention.

Step 1000 consists in the reception of a direct link report request for generating a direct link report for a given direct link session involved a source station, referred to as DL SRC station, and a destination station, referred to as DL DST station.

The direct link report request may be generated at different instant. For instance, a direct link report request can be generated either the establishment of the corresponding direct link or not. If the direct link session is established, it means that the DL SRC station knows the association identifier (AID) of DL DST station exchanged during the establishment. If the direct link session is not established, DL SRC station doesn't know AID of DL DST station. In such a case, DL SRC station identifies DL DST station by using the MAC address of the DL DST station.

Moreover, the direct link report request can be generated once, regularly or on-demand according to the 802.11 features implemented in the non-AP stations and AP.

Moreover, according to a first embodiment of the invention, the direct link report request is an internal request generated by the DL SRC station. According to a second embodiment of the invention, the request is an external message and has been generated and sent by the AP. The direct link report request contains at least an AID of a source station, referred to REQ DL SRC station and a direct link session identifier. An example of direct link session identifier may be the AID or the MAC address of the destination station (referred to REQ DL DST station).

Based on it, step 1001 determines whether a corresponding direct link session is established between REQ DL SRC station (corresponding to DL SRC station) and REQ DL DST station. If yes, next step is 1002. If not, next step is 1003.

Step 1002 computes and generates a DL report based on AID format. In such a case, the AID of REQ DL DST is known. DL report is described with reference to FIG. 8. According to a first embodiment, field 801 is set to a direct link session identifier as for instance the AID of REQ DL DST. Field 802 corresponds to the implementation type of DL report to be generated. If its value is equal to 00, the DL report contains the set of fields 264. If its value is equal to 2, the DL report contains the set of fields 264. If its value is equal to 1, the DL report contains the set of fields 400. According to a second embodiment, field 801 is not present and field 802 is set to 1. In such a case, the DL report contains the set of fields 910. In such a case, subfield 914 contains the AID of REQ DL DST.

Step 1003 computes and generates a DL report based on MAC address format. In such a case, the AID of REQ DL DST is not known, only the MAC address of the REQ DL DST is known. DL report is described with reference to FIG. 8. Field 801 is set to the MAC address of REQ DL DST. Field 802 corresponds to the implementation type of DL report to be generated. If its value is equal to 00, the DL report contains the set of fields 264. If its value is equal to 2, the DL report contains the set of fields 264. If its value is equal to 1, the DL report contains the set of fields 400.

Step 1004 transmits the DL report generated either in step 1002 or in step 1003 to the AP for which the DL SRC station is associated.

By adopting a correct reporting by stations 600 according to embodiments of the invention, the resource unit allocation is more efficient in dense scenarios like envisaged in 802.11ax. The allocation of wireless resources by the access point is performed in regards to the real needs of non-AP stations for their direct transmissions towards other non-AP stations.

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of communication in a wireless network comprising an access point and stations, the method comprising by at least one emitting station having data to be directly transmitted to at least one destination station different from the access point:
generating a status report to be transmitted to the access point, said status report indicating an amount of data of at least an emission buffer of the emitting station, said data been directed to one of the said at least one destination station; and
transmitting said status report to the access point;
wherein said status report allows the access point to reserve a wireless resource for the direct transmission between the emitting station and the destination station to which data are directed; and
wherein the status report contains an identification element for identifying the destination station, and wherein the wireless resource is reserved by the access point based on the amount of data indicated in the status report and the identification element contained in the status report.

2. The method of claim 1, wherein the wireless resource is a resource unit splitting a transmission opportunity granted to the access point.

3. The method of claim 1, wherein the status report is a buffer status report indicating an amount of data stored in at least an emission buffer of the emitting station.

4. The method of claim 1, wherein the status report is a traffic specification report indicating an amount of data expected to be stored in at least an emission buffer of the emitting station.

5. The method of claim 1, wherein data to be transmitted to a non-access point station are to be emitted according to an established direct link, and the identification element is a destination station identifier.

6. The method of claim 1, wherein data to be transmitted to a non-access point station are to be emitted according to a non-established direct link, and the identification element is the destination station MAC address.

7. The method of claim 1, wherein data to be transmitted to a non-access point station are to be emitted according to an established direct link, and the identification element is an identifier of the established direct link.

8. A communication device in a wireless network comprising an access point and a plurality of stations, the communication device, acting as an emitting station having data to be directly transmitted to at least one destination station different from the access point, comprising at least one microprocessor configured for carrying out the steps of:
generating a status report to be transmitted to the access point, said status report indicating an amount of data of at least an emission buffer of the emitting station, said data been directed to one of the said at least one destination station; and
transmitting said status report to the access point;
wherein said status report allows the access point to reserve a wireless resource for the direct transmission between the emitting station and the destination station to which data are directed; and
wherein the status report contains an identification element for identifying the destination station, and wherein the wireless resource is reserved by the access point based on the amount of data indicated in the status report and the identification element contained in the status report.

9. A computer program product for a programmable apparatus, the computer program product comprising a sequence of instructions for implementing a method according to claim 1, when loaded into and executed by the programmable apparatus.

10. A computer-readable storage medium storing instructions of a computer program for implementing a method according to claim 1.

11. The method of claim 2, wherein the status report is a buffer status report indicating an amount of data stored in at least an emission buffer of the emitting station.

12. The method of claim 2, wherein the status report is a traffic specification report indicating an amount of data expected to be stored in at least an emission buffer of the emitting station.

13. The method of claim 2, wherein data to be transmitted to a non-access point station are to be emitted according to an established direct link, and the identification element is a destination station identifier.

14. The method of claim 2, wherein data to be transmitted to a non-access point station are to be emitted according to a non-established direct link, and the identification element is the destination station MAC address.

15. The method of claim 2, wherein data to be transmitted to a non-access point station are to be emitted according to an established direct link, and the identification element is an identifier of the established direct link.
